(19) United States
(12) Patent Application Publication
(10) Pub. No.: US 2003/0015585 A1
(43) Pub. Date: Jan. 23, 2003

(54) Self checkout system utilizing networked shopping carts

(75) Inventors: Charles K. Wike JR., Sugar Hill, GA (US); Robert L. Snyder, Suwanee, GA (US)

Correspondence Address: Paul W. Martin, NCR Corporation, Law Department, WHQ-5E, 1700 S. Patterson Blvd., Dayton, OH, 45479-0001, US

(73) Assignee: NCR Corporation

(21) Appl. No.: 09/909,346

(22) Filed: Jul. 19, 2001

(51) Int. Cl. G06K 15/00

(52) U.S. Cl. 235/383

(57) ABSTRACT

A self checkout system, method, and apparatus for a retail establishment includes a plurality of product receptacles, such as shopping carts, each having a product data receiver that is operative to obtain product data for products placed in the product receptacle. The obtained product data is transmitted via a wireless channel to a central processor or computer. Each product data receiver may also provide a display of various product data. During checkout, product receptacle data is obtained, such as weight, and compared against the product data in the central computer for verification purposes. When verified, payment is made at the checkout before bagging of the products. If there is a discrepancy (i.e. no verification), an assisted checkout is then used.

### FIELD OF THE INVENTION

The present invention relates generally to checkout systems for retail businesses and, more particularly, to a self-service checkout system for retail businesses.

### DESCRIPTION OF THE PRIOR ART

In the retail industry, self-checkout systems may be deployed in order to help facilitate a faster checkout experience for the consumer. Such self-service checkout systems are typically installed in grocery stores and the like. These self-service checkout systems require the consumer to scan the item or items for purchase and then place the scanned item or items on a security scale. The security scale is used to identify and isolate the item or items in order to perform a checkout security check.

This method of self-service checkout takes a great deal of time, as most consumers are not very fast at scanning items. Because of frustrations associated with poor scanning ability, the consumer is not completely satisfied with the experience. This causes the consumer to avoid the self-service checkout and instead use an assisted checkout. It is, however, in the interest of the retailer to have a consumer use a self-service checkout.

One solution to the above problems in an attempt to have consumers use a self-service checkout is to equip a shopping cart with its own retail terminal including a scanner. The consumer can then scan the items before placing them in the shopping cart. The price for each scanned item may be shown on a display associated with the on-cart retail terminal. At checkout, the shopping cart is then weighed on a scale at a self-service checkout station. The weight of the shopping cart is compared with the weight of the goods as determined by the on-cart retail terminal and the scale. Payment may then be made at the checkout. A problem with this approach, however, is that the on-cart retail terminal requires an expensive local controller and other circuitry and/or components to keep track of each item scanned. In addition, the on-cart retail terminal does not provide intrinsic reliability and current pricing of goods.

It is thus an object of the present invention to provide an improved self-service checkout system, method, and/or apparatus.

It is another object of the present invention to provide a self-service checkout system, method, and/or apparatus that minimizes the amount of time necessary to check out of a retail business.

### SUMMARY OF THE INVENTION

The present invention is a system, method, and apparatus that provides self-service checkout. In particular, the present invention provides a self checkout system, method, and apparatus for a retail establishment includes a plurality of product receptacles, such as shopping carts, each having a product data receiver that is operative to obtain product data for products placed in the product receptacle. The obtained product data is transmitted via a wireless channel to a central processor or computer. Each product data receiver may also provide a display of various product data. During checkout, product receptacle data is obtained, such as weight, and compared against the product data in the central computer for verification purposes. When verified, payment is made at the checkout before bagging of the products. If there is a discrepancy (i.e. no verification), an assisted checkout is then used.

In one form, the present invention provides a method of providing self-service checkout of items in a store. The method includes a) receiving item data from an item into an item data receiver associated with a portable item receptacle, b) transmitting the item data from the item data receiver to a central processor, c) receiving item receptacle data into the central processor, and d) verifying if the received item receptacle data correlates to the received item data.

In another form, the present invention provides a system for self-service checkout of items in a store. The system includes a main processing unit, an item data receiver associated with a portable item receptacle and operative to obtain item data from an item, a transmitter associated with the item data receiver and operative to transmit obtained item data, a transmission receiver in communication with the main processing unit and operative to receive transmitted obtained item data, and a self-service checkout terminal in communication with the main processing unit. The self-service checkout terminal includes a receptacle data receiver operative to obtain item receptacle data from the portable item receptacle and is operative to correlate the obtained item receptacle data with the obtained item data.

In a particular form, the present invention provides a self-service checkout system that includes a product data receiver associated with a portable product receptacle, a central computer, a database, and a self-service checkout terminal. The product data receiver is associated with a portable product receptacle and includes a scanner operative to read a bar code on a product, and a wireless transmitter operative to receive the read bar code from the scanner and wirelessly transmit the read bar code. The central computer includes a wireless transmission receiver operative to receive a wireless transmitted bar code from the product data receiver. The database is in communication with the central computer and is operative to correlate a received bar code with stored product data. The self-service checkout terminal is in communication with the central computer and is operative to receive portable product receptacle data and compare the received portable product receptacle data with the stored product data from the database and, if the received portable product receptacle data correlates with the stored product data as determined from the received bar code then allow receipt of payment, else deny receipt of payment.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying drawings, wherein:

FIG. 1 is a diagrammatic representation of an exemplary system in accordance with the principles of the present invention;

FIG. 2 is a diagrammatic representation of an aspect of the exemplary system of the present invention;

FIG. 3 is a representation of an exemplary product in accordance with the principles of the present invention;

FIG. 4 is a block diagram of an exemplary product data receiver in accordance with the principles of the present invention;

FIG. 5 is a block diagram of the exemplary central computer system of the present invention in accordance with the principles presented herein;

FIG. 6 is a diagrammatic representation of an exemplary self-service checkout terminal in accordance with the principles presented herein; and

FIG. 7 is a flow chart of an exemplary manner of operation of the present invention.

Corresponding reference characters indicate corresponding parts throughout the several views.

### DETAILED DESCRIPTION

While the invention is susceptible to various modifications and alternative forms, the specific embodiment(s) shown and/or described herein is by way of example. It should thus be appreciated that there is no intent to limit the invention to the particular form disclosed, as the intention is to cover all modifications, equivalents, and alternatives falling within the spirit and scope of the invention as defined by the appended claims.

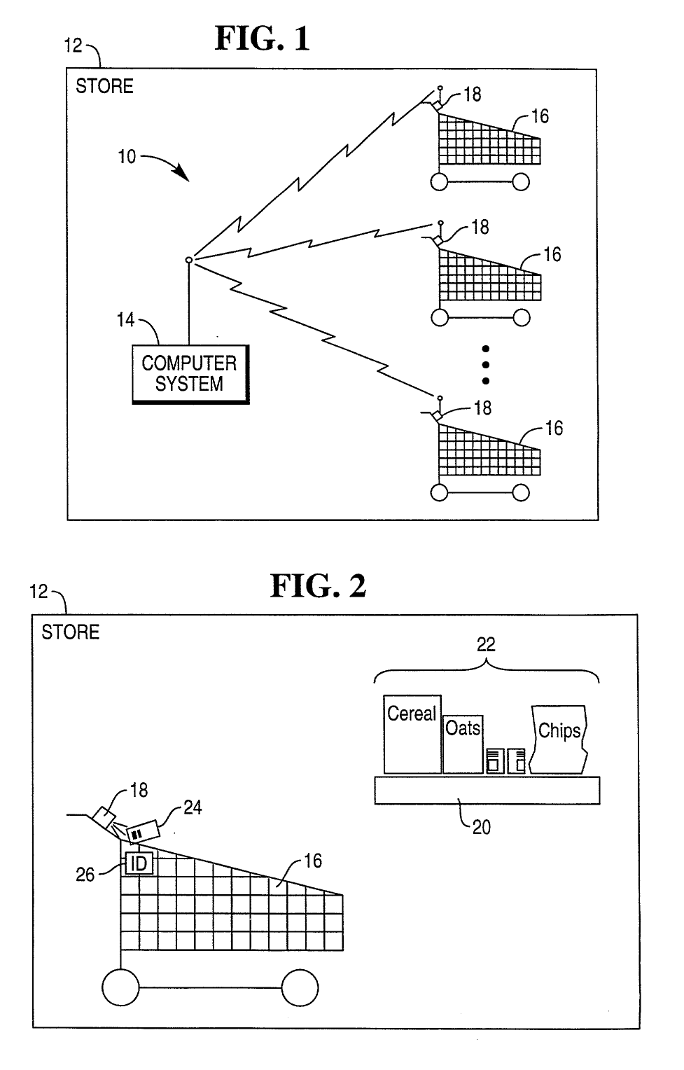

Referring to FIG. 1 there is shown a system, generally designated 10, within a store 12. The system 10 is exemplary or representative of an embodiment that is operative to carry out the principles of the present invention. As well, the store 12 is exemplary or representative of any type of store, retail, or wholesale establishment, although in the present example the store 12 is a retail business and, more particularly, a grocery store, superstore, or the like. The store 12 includes a computer system 14 that functions as a main or central processing system or unit. It should be appreciated that while the central processing system or unit 14 is described and referred to herein as a computer system, any type of processing system, device or unit that functions in the manner set forth herein may be used. The computer 14 may be any type of suitable computer system.

The system 10 also includes at least one portable product receptacle and preferably a plurality of portable product receptacles, here depicted as shopping carts 16. The portable product receptacles 16 may take other forms such as shopping baskets, totes or the like that are functional to carry products or items for a shopper as the shopper moves throughout the store 12. Each portable product receptacle 16 includes a product data receiver or unit 18.

In accordance with an aspect of the present invention, each product data receiver 18 is operative to produce and send wireless transmissions represented by an antenna associated with each product data receiver 18 and a jagged wave emanating therefrom. The computer system 14 is operative to receive the wireless transmissions from the product data receivers 18 represented by an antenna associated with the computer system 14. The computer system 14 may be operative to send wireless transmissions to each of the product data receivers 18 and thus each product data receiver 18 would then be operative to receive wireless transmissions. However, unless otherwise specifically indicated, it is assumed that the wireless transmissions emanate from a product data receiver 18 and is received by the computer system 14.

The range of the wireless transmissions is such that they can be transmitted from any part of the store 12 and be received by the computer system 14. Such wireless transmissions can take any form, protocol, power and/or frequency, but preferably is within a suitable, public frequency range and power such that the system 10 can be safely operated at any location.

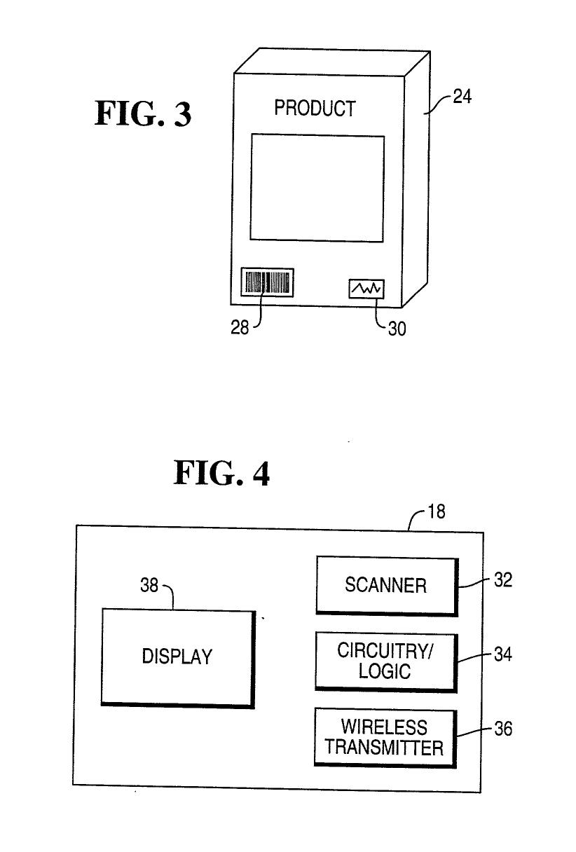

Referring to FIG. 2, the store 12 includes products or items 22 that are typically located on a shelf 20 or other display area. The portable product receptacle 16 is taken along with the shopper (not shown) up and down the various isles and rows of products 22 of the store 12. Each portable product receptacle 16 preferably includes a machine-readable identification (ID) tag 26. The identification tag 26 may be a bar code, a radio frequency ID (RFID), or any other type of identifier that is readable in some manner by a machine. Each product data receiver 18 is operative to scan or read (collectively, scan) a scannable or machine-readable portion of the product 24 before or while the product 24 is being placed into the portable product receptacle 16. Referring to FIG. 3, the product 24 may have a bar code 28, an RFID tag 30, or any other type of scannable or machine-readable indicia thereon (collectively, product identification data) that is obtainable by the product data receiver 18. The product data receiver 18 thus obtains the product identification data from the product 24 as it is scanned.

In accordance with an aspect of the present invention, the product data receiver 18 is operative to transmit the received product identification data to the computer system 14. Accordingly, each product data receiver 18 preferably has and sends a product data receiver identifier to the computer system 14 along with the product identification data in order for the computer system 14 to keep track of the various products that are going into the portable product receptacle 16 for purchase. The product data receiver identifier may be the same as the portable product receptacle tag 26 such that the portable product receptacle 16 and the product data receiver 18 are paired, or may be a separate identifier that is matched up by the computer system 14. In the later case, a separate identifier for the portable product receptacle 16 and the product data receiver 18 allows for easier replacement of a product data receiver 18 should that be necessary.

Referring to FIG. 4, a block diagram of the product data receiver 18 is shown. The product data receiver 18 includes a scanner 32 of any type that is operative to read/obtain the product identification data from the product 24. A wireless transmitter 36 is provided that is operative to transmit the product identification data to the computer system 14. While the wireless transmitter 36 may be any kind of transmitter utilizing any type of protocol, frequency, and/or power, one type of wireless transmitter may be Bluetooth™ (see www.bluetooth.com). Circuitry/logic 34 is provided that connects the scanner 32 with the wireless transmitter 36, as well as provide other necessary connections and/or appropriate functionality to the product data receiver 18 such as power from batteries (not shown), any data formatting for transmission not performed by the wireless transmitter 36, and/or the like. The product data receiver 18 may also include a display 38 that is operative to show various information about the scanned product, as well as other information/data, advertisements, promotions, and the like.

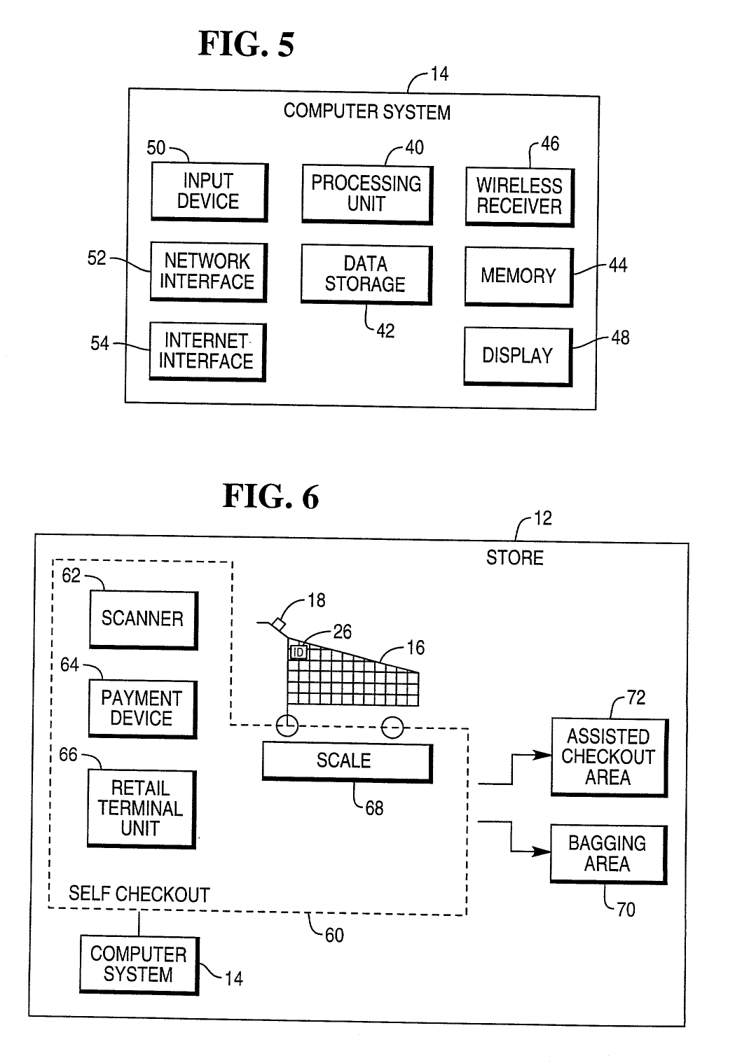

In conjunction with FIG. 5, the computer system 14 is operable to receive the product identification data that is transmitted by the product data receiver 18 via a wireless receiver 46. In one form, the wireless receiver 46 utilizes the Bluetooth™ protocol/manner of communication. The wireless transmitter 36 of the product data receiver 18 provides data to the wireless receiver 46 of computer system 14 in a preferably serial manner, such that the wireless transmitter 36 functions, behaves, or looks like a serial port. The computer system 14 includes a processing unit 40 of any type, memory 44, a display 48, data storage 42, an input device 50, a network interface 52 (intranet, LAN or the like), and an Internet interface 54. The memory 44 is operative to at least temporarily store program instructions for execution by the processing unit in order for the processing unit 40 and thus the computer system 14 to function and/or perform in the manner set forth herein. The data storage 42 contains a database or databases of product data, product data receiver identifiers, and portable product receptacle identifiers, as well as any other pertinent data. The product data database allows the computer system 14 to correlate received product data identifiers with pertinent product data such as product weight, product price, product dimensions, and the like. The data storage is also operative to keep track of the various products and/or product data from its database for products that are being scanned into a particular product data receiver 18. The computer system 14 is also operative to track a plurality of product data receivers. Thus, as each shopper scans their chosen products into the product data receiver 18 associated with their portable product receptacle, the product data receiver 18 wirelessly transmits the product identifier and/or information to the wireless transmission receiver 46 of the computer system 14 which maintains a list and/or keeps track of the products for later correlation and/or verification during serf-service checkout.

Referring to FIG. 6, self-service checkout occurs at a self-service checkout station 60. The self-service checkout 60 includes a scanner or scanning device 62, a payment acceptor device 64, a retail terminal/processing unit 66, and a scale 68. The self-service checkout 60 is also in communication with the computer system 14. Physically, the self-service checkout 60 is ahead of a bagging area 70 where purchases products are bagged, and an assisted checkout area 72 that is operated by a clerk (store employee) in case there is a problem during the self-service checkout procedure that cannot be rectified at the self-service checkout 60, or there is no verification of the self-service checkout procedure as explained below.

The retail terminal unit 66 contains necessary circuitry/logic and/or program instructions that allow the self-service checkout terminal 60 to operate and/or function in the manner set forth herein, including coordination of the various inputs from the various input devices (i.e. the scale 68 and the payment acceptor device 64). The scale 68 is operative to weight the portable product receptacle 16, while the scanner 62 is operative to read the portable product receptacle identifier 26. The scanner 62 may be operative to read an identifier associated with the product data receiver 18 in addition to or in lieu of reading the portable product receptacle identifier 26. The self-service checkout 60 is operative to communicate with the computer system 14 for verification and/or correlation of the data received from the portable product receptacle 16 and/or the product data receiver 18 during the self-service checkout procedure. The payment acceptor device 64 is operative to accept payment for the purchase via a magnetic card, a smart card, cash, check, or the like.

When the shopper completes their shopping, the portable product receptacle 16 is placed on the scale 68 as depicted in FIG. 6. The weight of the portable product receptacle 16 with the various products therein is measured to obtain a total weight. The weight of the portable product receptacle is subtracted from the total weight to obtain the actual weight of the products. The actual weight of the products is compared to a calculated weight of the products as determined by the computer system 14. The computer system 14 obtains the determined weights of products in its database from the product identifiers transmitted to it by the product data receiver 18 that matches the identifier of the portable product receptacle 16 currently on the scale and/or the identifier of the product data receiver 18 currently on the scale. It should be appreciated that other product data may be used to provide verification and/or correlation of the product contents of the portable product receptacle and the products scanned into the product data receiver 18 of the particular portable product receptacle.

If there is verification of the contents of the portable product receptacle 18, the self-service checkout 60 is operative to accept payment via the payment acceptor device 64. Thereafter, the portable product receptacle 16 is moved to the bagging area 70 where the purchased products may be bagged. If however, the contents of the portable product receptacle 16 is not verified or correlated during the self-service checkout procedure, the self-service checkout device 60 will not accept payment for the products, thus requiring that the portable product receptacle be transported to the assisted checkout area 72 for processing.

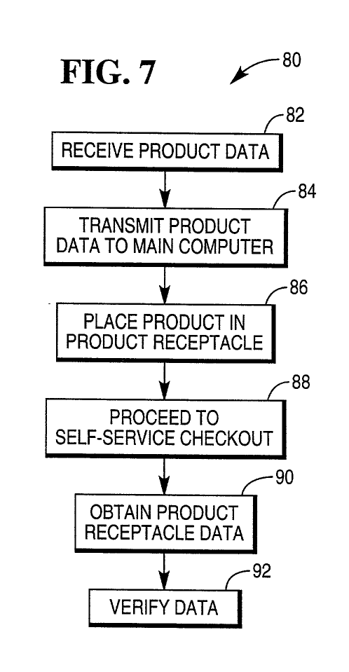

Referring to FIG. 7, there is depicted a flow chart, generally designated 80, of an exemplary manner of operation of the present invention in accordance with the principles presented herein. As a shopper obtains products and scans them into the product data receiver 18, the product data receiver 18 receives product data (product identification data), block 82. The product data receiver 18 then wirelessly transmits the product identification data to the main or central computer, block 84, where the computer stores the product identification data with respect to either or both the portable product receptacle and the product data receiver in order to keep track of (make a running list) the various products entered into the product data receiver. The consumer/shopper then places the entered product into the product receptacle, block 86. Blocks 82, 84, and 86 occur each time a product is chosen for purchase.

After the consumer has selected, entered, and placed the product or products into the portable product receptacle, the consumer takes the portable product receptacle 16 to the self-service checkout 60, block 88. The self-service checkout 60 obtains portable product receptacle data, block 90. The portable product receptacle data is then compared to stored product data corresponding to the list compiled by the computer 14 from the transmitted data received thereby in order to verify if the contents of the portable product receptacle matches, block 92. Depending on the verification results, a different action may be taken as explained above.

It should be appreciated that the various aspects of the present invention have herein been described separately. The various aspects, however, may be combined in any manner.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the claims.

What is claimed is:

1. A method of providing self-service checkout of items in a store comprising:
receiving item data from an item into an item data receiver associated with a portable item receptacle;
transmitting the item data from the item data receiver to a central processor;
receiving item receptacle data into the central processor; and
verifying if the received item receptacle data correlates to the received item data.

2. The method of claim 1, wherein verifying if the received item receptacle data correlates to the received item data includes allowing payment for the item if the received item receptacle data correlates to the received item data, else denying payment for the item and providing direction to an assisted checkout.

3. The method of claim 1, further comprising:
displaying the item data on the item receiving unit.

4. The method of claim 1, wherein receiving item data includes scanning an item with a scanner.

5. The method of claim 1, wherein transmitting the item data from the item data receiver includes transmitting the item data through a wireless serial port.

6. The method of claim 5, wherein transmitting the item data through a wireless serial port includes utilizing Bluetooth™.

7. The method of claim 1, wherein receiving item receptacle data includes obtaining a weight of the item receptacle.

8. The method of claim 7, wherein verifying if the item receptacle data correlates to the received item data includes obtaining a weight of the item using the received item data and comparing the obtained weight of the item receptacle with the obtained weight of the item.

9. The method of claim 8, wherein obtaining a weight of the item using the received item data includes retrieving weight data from a database.

10. A system for self-service checkout of items in a store comprising:
a main processing unit;
an item data receiver associated with a portable item receptacle and operative to obtain item data from an item;
a transmitter associated with said item data receiver and operative to transmit obtained item data;
a transmission receiver in communication with said main processing unit and operative to receive transmitted obtained item data; and
a self-service checkout terminal in communication with said main processing unit and including a receptacle data receiver operative to obtain item receptacle data from said portable item receptacle, said self-service checkout terminal operative to correlate the obtained item receptacle data with the obtained item data.

11. The system of claim 10, wherein said item data receiver comprises a scanner.

12. The system of claim 10, wherein said transmitter and said transmission receiver utilize Bluetooth™.

13. The system of claim 10, wherein said receptacle data receiver comprises a scale.

14. The system of claim 10, wherein said self-service checkout includes a payment acceptor operative to obtain payment for an item when the item receptacle data is verified against the obtained item data during correlation.

15. A self-service checkout system comprising:
a product data receiver associated with a portable product receptacle and having a scanner operative to read a bar code on a product, and a wireless transmitter operative to receive the read bar code from the scanner and wirelessly transmit the read bar code;
a central computer having a wireless transmission receiver operative to receive a wireless transmitted bar code from said product data receiver;
a database in communication with the central computer and operative to correlate a received bar code with stored product data; and
a self-service checkout terminal in communication with the central computer and operative to receive portable product receptacle data and compare the received portable product receptacle data with the stored product data from the database and, if the received portable product receptacle data correlates with the stored product data as determined from the received bar code then allow receipt of payment, else deny receipt of payment.

16. The self-service checkout system of claim 15, further comprising:
a display associated with the product data receiver and operative to show product data after a product bar code has been scanned by the scanner.

17. The self-service checkout system of claim 15, further comprising a payment acceptor associated with the self-service checkout terminal.

18. The self-service checkout system of claim 17, wherein the payment acceptor is operative to receive payment via at least one of a magnetic strip card, a smart card, a check, and cash.

19. The self-service checkout system of claim 15, wherein the wireless transmitter and the wireless transmission receiver utilize Bluetooth™.

20. The self-service checkout system of claim 15, wherein the product data receiver includes a display operative to show data relating to a scanned product.
